(19) United States
(12) Patent Application Publication
(10) Pub. No.: US 2023/0316890 A1
(43) Pub. Date: Oct. 5, 2023

(54) Multi-functional Porch Light and Signaling System

(71) Applicant: Daniel Allan, Gunter, TX (US)

(72) Inventor: Daniel Allan, Gunter, TX (US)

(21) Appl. No.: 18/329,478

(22) Filed: Jun. 5, 2023

Related U.S. Application Data
(63) Continuation-in-part of application No. 16/781,967, filed on Feb. 4, 2020.
(63) Continuation-in-part of application No. 16/666,942, filed on Oct. 29, 2019.
Application No. 16/781,967 is a continuation-in-part of application No. 16/666,942, filed on Oct. 29, 2019.
(60) Provisional application No. 62/801,089, filed on Feb. 4, 2019.
(60) Provisional application No. 62/801,089, filed on Feb. 4, 2019.

(51) Int. Cl. G08B 21/22

(52) U.S. Cl. CPC G08B 21/22

(57) ABSTRACT

The present invention relates to a multi-functional alerting device and signaling system designed to provide a wide range of features and applications. The alerting device and signaling system identifies a location and further generates alerts on identification of the location.

### CROSS-REFERENT TO RELATED APPLICATIONS

This application claims the benefit of U.S. Provisional Application No. 62/801,089, filed Feb. 4, 2019 and entitled “Systems and Methods for Protecting Occupants from an Attack,” U.S. Pat. Application No. 16/666,942, filed Oct. 29, 2019 and entitled “Systems and Methods for Creating and Identification Signal,” and U.S. Pat. Application No. 16/781,967, filed Feb. 4, 2020 and entitled “Systems and Methods for Protecting Occupants From an Attack,” each of which are incorporated herein by reference in their entireties.

### FIELD OF INVENTION

The present invention is generally directed to the field of signaling system for finding or identifying a location. More particularly, the present invention relates to signaling systems for locating a location and further generating alerts on identification of the location.

### BACKGROUND

Location identification is of great importance in many scenarios, such as, for example, emergency situations. It can be crucial to be able to quickly and accurately locate persons or any specific location. As an example, in the event of emergency situations, such as when paramedics, fire fighters, or police officers have been called to a location, every second matters. The faster those emergency personnel get to the proper location, the probability of a positive outcome increases.

In other examples, when delivery personnel wants to deliver a parcel to a particular location, the delivery personnel needs to reach or a locate delivery address as quickly as possible. The delivery personnel locates the delivery location by getting a signal over the location and verify the location as soon as possible to deliver the parcel efficiently and at a quicker time. The delivery personnel further verifies the location as soon as possible to deliver the parcel efficiently and at a quicker time.

In yet other examples, business is conducted often over the computer or phone. As such, two people need to meet without having spoke or met previously. This can lead to unsafe situations in which people aren’t certain that they are meeting with the right person.

A signal is required for verifying the identification of the other person to increase the safety of such situations. Such examples, can include, but is not limited to, ride sharing apps, dating apps, and towing services where verification of location is required.

### BRIEF DESCRIPTION OF THE DRAWINGS

To facilitate further description of the embodiments, the following drawings are provided. The same reference numerals in different figures denote the same elements.

FIG. 1 illustrates a block diagram of an example embodiment of a system for identifying a location in accordance with the present invention;

FIG. 2 illustrates a block diagram of an example embodiment of an alerting device for identifying a location and providing alerts on identification of the specified location in accordance with the present invention;

FIG. 3(A) illustrates an exemplary embodiment of integration of the alerting device on a residential structure such as home and alike in accordance with the present invention;

FIGS. 3 (B) illustrates an exemplary embodiment of integration of an alerting device on a commercial or residential structure accordance with the present invention;

FIG. 3(C) illustrates an example of a person struck in an emergency or a distress situation, inside a home, a building like structure in accordance with the present invention;

FIGS. 4 (A) illustrates an exemplary embodiment of the integration of an alerting device integrated in a building for a precise location identification and in turn providing alerts to a delivery personnel for delivering product in accordance with the present invention;

FIGS. 4 (B) illustrates an exemplary embodiment of utilization of an alerting device on vehicles in accordance with the present invention;

FIG. 5 illustrates a an exemplary embodiment of the utilization of an alerting device as a verification system for various services in accordance with the present invention; and

FIG. 6 illustrates a example method for identifying a location based on one or more events, in accordance with the present invention.

### DETAILED DESCRIPTION

In accordance with the present invention, a multi-functional signaling system and device can combine visual and audio signals with advanced connectivity and integration capabilities to enhance safety, convenience, and communication in various scenarios.

The present invention discloses a system for identifying a location and providing alerts on reaching the specific location or verification of the location. The location may be any location or any specific location. The location or specific location may be either location of a person or a physical object.

The system includes a data aggregator for collecting the data from one or more events. In one embodiment of the present invention, the data aggregator works in conjugation with mobile applications for collecting data of one or more events. The mobile application can be any delivery application, such as, for example, a dating application, car servicing application, towing services application, ride sharing application, food delivery application, emergency distress application and alike mobile applications. The data aggregator collects data from nearby mobile devices, a wireless network, or can capture legally permissible cell phone information. In one embodiment of the present invention, the one or more event is can comprise an emergency situation, delivery, tracking of a person, towing of a vehicle, dating services, trade services, ride sharing services, emergency situation and the like.

The system comprises a processor for processing details of one or more events. Further, the system comprises an authentication module for receiving and authenticating the data received from the data aggregator to generate an authenticated data related to the one or more events. Further, the system includes a selection module for selecting an event from the authenticated data based on a set of pre-defined rules. In one embodiment of the present invention, the set of pre-defined rules can comprise a location dependent occurrence of the one or more events and a generation of alerts. Further, the system can comprise a selection module for selecting an event from the authenticated data based on a set of pre-defined rules. Further, the system can comprise a generation module for generating a signal based on a selected event.

Further, the system can comprise a signaling module for generating at least one alert based on the signal to identify the location. The alert is either visual alerts, audible alerts, or both visual and audible alerts. The alert can be a customizable alert that is customized according to requirements of the user. In one example, the signaling module can comprise a multi-functional porch light capable of emitting both visual and audible alerts depending upon the customized requirements of a user.

In one alternative embodiment of the present invention, an alerting device for identifying a location and providing alerts on identification of the specified location is disclosed. The alerting device can comprise a data aggregating unit collects data from one or more events. The location or the specified location can be, for example, a location of a person, a building, shelter, vehicles, cars, delivery personnel, and the like. In one embodiment of the present invention, the data aggregator can work in conjugation with mobile applications for collecting data of one or more events. The mobile application can comprise, for example, any delivery application, dating application, car servicing application, towing services application, ride sharing application, food delivery application, emergency distress application, and similar mobile applications. The data aggregator can collect data from nearby mobile devices, a wireless network, or capture legally permissible cell phone information. In one embodiment of the present invention, the one or more event can comprise an emergency situation, food delivery, tracking of a person, towing of a vehicle, dating services, trade services, ride sharing services, and similar situations.

The alerting device comprises a processor for processing details of one or more events. Further, the alerting device comprises an authentication module for receiving and authenticating the data received from the data aggregating unit to generate an authenticated data related to the one or more events. Further, the alerting device comprises a selection module for selecting an event from the authenticated data based on a set of pre-defined rules. In one embodiment of the present invention, the set of pre-defined rules can be based on the one or more events, the location, and the at least one alert.

Further, the alerting device comprises an alerting module that comprises a generation module for generating a signal based on the event to identify the location. Further, the alerting device comprises a signaling module for generating a signal based on a selected event.

Further, the alerting device can provide alerts based on the signal to identify and verify a location. The alert can comprise visual alerts, audible alerts, or a combination thereof. The alert can be customized according to requirements of the user. For example, if the device comprises a porch light, it can be capable of emitting both visual and audible alerts depending upon the customized requirements of a user. The alerting device can be capable of multiple different types of displays. For example, the display can comprise emitting a multi-color light, a predefined pattern of light, or flashing of light. The alerting device can be capable of generating audible alerts of different frequencies.

The device works is capable of working in conjugation with a mobile application, wherein the mobile application can comprise any application, including, for example, a delivery application, dating application, car servicing application, towing services application, ride sharing application, food delivery application, emergency distress application, and any other mobile applications. The device can be controlled via wired connectivity or wireless connectivity, wifi, 3g, 4g, 5g, satellite, and similar connections now known or hereinafter developed. The device can comprise a smart bulb, LED bulbs, flash light, or any smart device emitting both visual and/or audible notifications. The device can be a customizable device comprising the ability of emitting a multi-color light, flashing the light in pre-defined patterns, emitting a range of audible sounds, and emitting both visual and audible alerts in a specific pattern.

In an alternative embodiment of the present invention, a method for identifying a location based on one or more events is disclosed. The method comprises a step of aggregating the data from the one or more events. Further, the method comprises a step of receiving and authenticating the data received to generate an authenticated data related to the one or more events. Further, the method comprises a step of selecting an event based on the authenticated data by applying a set of pre-defined rules on the authenticated data. Further, the method comprises generating a signal based on the event to identify a location. Further, the method comprises generating an alert based on the location to identify and verify the location.

The present invention comprises a multi-functional signaling system and device that revolutionizes the way a user interacts with the surroundings, ensuring a safer and more connected environment to the user.

The present invention comprises a multi-functional signaling system and device that combines visual and audio signals with advanced connectivity and integration capabilities to enhance safety, convenience, and communication in various scenarios.

The present invention further comprises a multi-functional signaling system and device that can be utilized for package delivery notifications, emergency alerts, location identification, trust verification for ride services, and similar services.

Other objectives and aspects of the invention will become apparent from the following detailed description, taken in conjunction with the accompanying drawings, which illustrate, by way for example, the features in accordance with embodiments of the invention.

Although, the invention is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

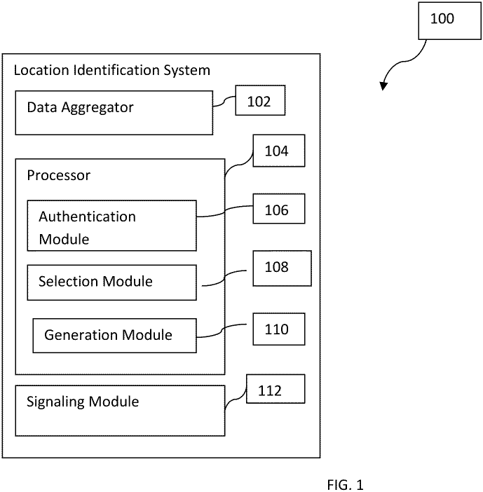

FIG. 1 illustrates an exemplary system (100) for identifying a location and providing alerts on reaching the location or verification of the location. The location may be any location or any specific location. The location or specific location may be either location of a person or a physical object or monuments, vehicles such as, but not limited to, a building, shelter, vehicles, cars, delivery personnel, and the like.

The system (100) includes a data aggregator (102) for collecting the data from one or more events. The data aggregator (102) may collect the data of the one or more events through an application installed on an electronic device. The electronic device may be a smart phone, a mobile device, a tablet, a computer, a palmtop or a laptop and alike electronic computing devices. In an embodiment of the present invention, the data aggregator (102) works in conjugation with mobile applications for collecting data of one or more events. The mobile application can be any application, such as, for example, delivery application, dating application, car servicing application, towing services application, ride sharing application, food delivery application, emergency distress application, and similar applications. In the same or another embodiment of the present invention, the data aggregator (102) collects data from nearby mobile devices, a wireless network, or captures legally permissible cell phone information from the mobile devices. In the same or other embodiments of the present invention, the one or more event comprises one or more of any emergency situation, such as, for example, fire, earthquake, and similar emergency situations; delivery services, such as, for example, parcel delivery, food delivery, medicine delivery, or any other delivery service; tracking of a person or object; towing of a vehicle; dating services; trade services; ride sharing services; and any other services.

System (100) comprises a processor (104) for processing details of the one or more events. Further, the system (100) comprises an authentication module (106) for receiving and authenticating the data received from the data aggregator (102) to generate an authenticated data related to the one or more events. Further, the system (100) comprises a selection module (108) for selecting an event from the authenticated data based on a set of pre-defined rules. In an exemplary embodiment of the present invention, the set of pre-defined rules an be based on the one or more events, the location, and the at least one alert. Further, the system (100) comprises a generation module (110) for generating a signal based on a selected event.

System (100) comprises a signaling module (112) for generating at least one alert based on the signal to identify the location. The alert can comprise either visual alerts, audible alerts, a combination of visual and audible alerts, or combinations thereof. The alert can be a customizable alert that is customized according to requirements of the user. In one example, the signaling module comprises a multi-functional porch light capable of emitting both visual and audible alerts depending upon the customized requirements of a user. In the same or other examples, the signaling module can comprise a smart light, a smart phone, a smart bulb, a porch light, a flashlight or similar devices capable of emitting visual and/or audible alerts or notifications or combinations thereof.

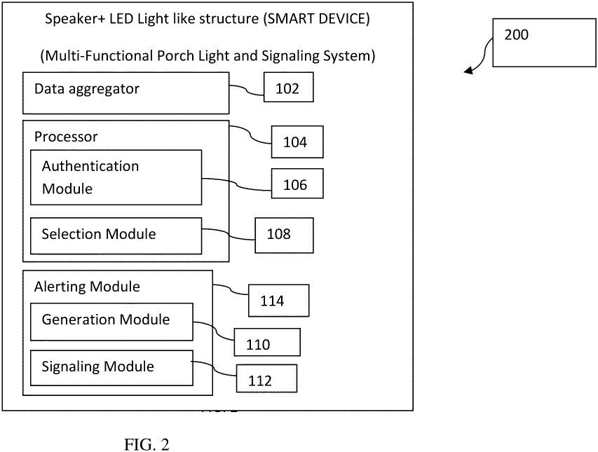

FIG. 2 illustrates an example of an alerting device (200) for identifying a location and providing alerts on identification of the location according to embodiments of the present invention. The alerting device (200) comprises a versatile device that integrates a range of functionalities to address the needs of modern-day interactions, safety, and convenience. In one or more exemplary embodiments, the alerting device (200) serves as a dynamic branded light that works in conjunction with a dedicated mobile application, providing seamless synchronization and control over various features and settings. The alerting device (200) can be implemented in various settings, such as, for example, residential areas, commercial buildings, and public spaces. In one or more embodiments, the modular design of the alerting device (200) allows for customization, enabling users to adapt the features to suit their specific needs and preferences.

Alerting device (200) comprises a data aggregator (102) that can collect data from one or more events. The location or the specified location comprise a location of a person, a building, shelter, vehicles, cars, delivery personnel, or any other object. In one or more embodiments of the present invention, the data aggregator (102) works in conjugation with mobile applications for collecting data of one or more events. The mobile application can comprise any delivery application, dating application, car servicing application, towing services application, ride sharing application, food delivery application, emergency distress application, or similar mobile applications. The data aggregator (102) can collect data from nearby mobile devices, a wireless network, or capture legally permissible cell phone information. In one or more embodiments of the present invention, the one or more events comprises an emergency situation, food delivery, tracking of a person, towing of a vehicle, dating services, trade services, ride sharing services, emergency situation, or any similar situations.

In one or more embodiments of the present invention, alerting device (200) comprises a processor (104) for processing details of one or more events. Further, the alerting device (200) comprises an authentication module (106) for receiving and authenticating the data received from the data aggregator (102) to generate authenticated data related to the one or more events. Further, the alerting device (200) comprises a selection module (108) for selecting an event from the authenticated data based on a set of pre-defined rules. In one or more embodiments of the present invention, the set of pre-defined rules is based on the one or more events, the location, and the at least one alert.

Further, in the same or other embodiments, the alerting device (200) comprises an alerting module (114) that comprises a generation module (110) for generating a signal based on the event to identify the location. Further, the alerting module (114) comprises a signaling module (112) for generating an alert or alerts based on a selected event.

In the same or other embodiments, the alerting device (200) can provide alerts based on the signal to identify and verify the location. The alert can be visual alerts, audible alerts, or combinations thereof. The alert can be a customizable alert that may bet customized according to requirements of the user. In one or more exemplary embodiments, alerting device (200) comprises a porch light capable of emitting visual alerts, audible alerts, or combinations thereof. The alerts may be customized depending upon the requirements of a user. In one or more embodiments, alerting device (200) may be capable of emitting a multi-color light, a predefined pattern of light, flashing light, or any other unique light or audio pattern that can be used to identify a location. In the same or other embodiments, alerting device (200) may be capable of generating audible alerts of different frequencies.

Alerting device (200) can work in conjugation with a mobile application. In one or more embodiments the mobile application comprises any delivery application, dating application, car servicing application, towing services application, ride sharing application, food delivery application, emergency distress application, or similar mobile applications. In the same or other embodiments, alerting device (200) can work in combination with emergency telephone numbers, such as, for example, 911. Alerting device (200) can be controlled via wired connectivity or wireless connectivity, WIFI, 3g, 4g, 5g, satellite, or any other type of connections. Alerting device (200) can comprise a smart bulb, LED bulbs, flashlight, or any other device capable of emitting visual and/or audible notifications. In one or more embodiments of the present invention, alerting device (200) can be a customizable device that can emit a multi-color light, flashing the light in pre-defined patterns, emit a range of audible sounds, emitting audible alerts in a specific pattern or frequencies, or combinations thereof.

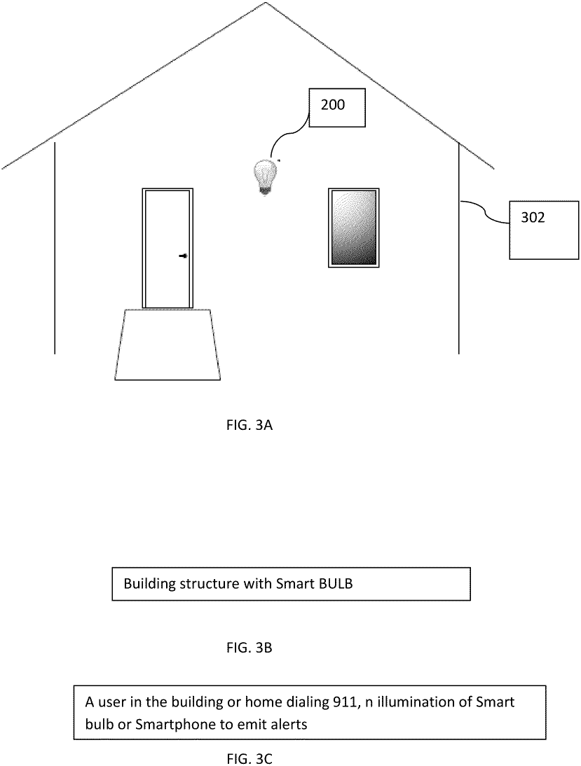

FIG. 3A illustrates one or more exemplary embodiments of integration of the alerting device (200) on a residential structure, such as, for example, a house, an apartment, or any other residential building. Alerting device (200) can comprise any smart device capable of emitting visual and/or audible alerts or notifications, such as, for example, a smart bulb, smart light, speaker with light, flashing light with audio alert emitter, and similar devices. In the same or other embodiments, the alerting device can comprise a ordinary light bulb that can be uniquely displayed. For example, the light bulb can be displayed to have a certain color, a unique flashing pattern, or any other display that can be used to make a location know to a user of the system. Device (200) can be controlled via wired connectivity or wireless connectivity, WIFI, 3G, 4G, 5G, satellite, and any other connection method now known or hereinafter developed.

In one example, alerting device (200) can be used during an emergency or distress situations when a user is inside a home or other location. When the user can dials 911 or uses any other mobile application for emergencies, alerting device (200) may be synced with the 911 system and/or emergency application. Alerting device (200) may then begin to send alerts, show alerts, or give notifications to any individual or organization chosen by the user of the system. In one or more preferred embodiments of the present invention, alerting device (200) comprises a smart bulb. When activated, alerting device (200) begins to flash and emits alerts depending upon the chosen notification method or pattern. In the same or other embodiments of the present invention, alerting device (200) comprises a smart phone that can be used by the user to emit visual and audible alerts. This in turn may alert neighbors, people passing by, that emergency assistance has been or needs to be summoned. That person may be assisted by anyone stopping to help them. In the same or other embodiments, this feature could be geo-fenced, such that the dialing of 911 would be limited to a specific distance from the house or building, so that false visual alerts being activated from a different location are not propagated.

FIG. 3B illustrates an exemplary embodiment of integration of alerting device (200) on a commercial or residential structure. In the event that an alarm or other monitor is activated, such as, for example, a fire alarm or security monitor, in one or more preferred embodiments of the present invention, alerting device (200) can be a smart light or any light that can be programmed to automatically notify the relevant authorities such as first responders and emergency services. In such a situation, the alerting device can be used to alert first responders of the location of the emergency. Simultaneously, alerting device (200) can also alert neighbors of a possible emergency situation and increase their awareness, or alert potential perpetrators that they have been spotted. The alerting device (200) allows first responders to locate the building, structure, or a person, where help is needed quicker by visually observing a flashing light, or in some circumstances, by hearing an audible alert. In case of emergencies such as fires or when immediate assistance is needed, alerting device (200) serves as an alert system. It could automatically notify first responders, neighbors, and others to create awareness and prompt action. In one example, police responding will have a higher certainty of the location of the person in distress, which would assist in making the approach to the location safer. Otherwise, the police may park directly in front of a building and put themselves in danger.

In one example, by pressing a button or dialing 911 on an approved phone by authorized personal, a signal will be activated, such as, for example, a flashing blue light, thus alerting all occupants in that building or pre-determined area, of an emergency, such as an active shooter.

FIG. 3(C) illustrates an example of when a person is struck in an emergency or a distress situation inside a structure or any other defined location. During emergency or distress situations, a user dials 911, the alerting device (200) comprises a light that emits a signal as discussed herein and further sends out alerts. The alerts can be sent to individuals or organizations. For example, a user’s emergency contact, doctor, family, first responders, or anybody else can be sent an alert. In some examples, the alerts can be sms messages, phone calls, or any other type of messaging system now or hereinafter developed.

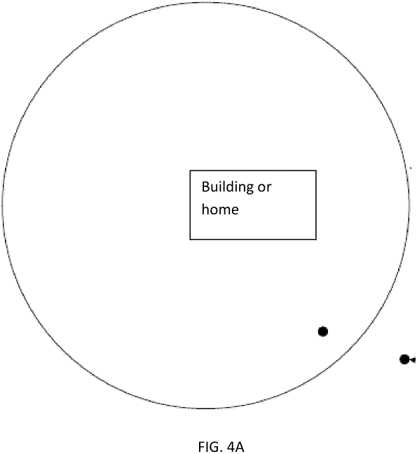

FIG. 4A illustrates an example of one or more embodiments of the integration of the alerting device (200) integrated on a location, such as, for example, a home, a building, or any other predefined location. In such examples the alerting device (200) can provide alerts to delivery personnel for delivering parcels, food, groceries, or any other deliverable objects. The delivery personnel may locate a delivery address quicker by the use of the visual aid emitted by the alerting device (200). In one or more examples, the alerting device (200) may activated when delivery personnel crosses a pre-determined distance from the predetermined location. The alerting device (200) may send out a signal, such as, for example, a flash of light in a certain pattern and/or color. In some examples, alerting device (200) may be capable of emitting a multi-color light, a predefined pattern of light or flashing of light. In the same or other examples, alerting device (200) is capable of generating audible alerts.

By synchronizing with any delivery application, such as, for example, a delivery application or food delivery service application, the alerting device (200) uses its signal to identify the location for the delivery, saving time and reducing errors. The alerting device (200) potentially works in crowded areas by using micro-locations or street-specific signals.

By integrating with popular delivery apps, alerting device (200) is used to streamline the delivery process. Upon arrival of a package, the alerting device (200) emit a distinctive visual, audio, or combined audio/visual signal, thereby notifying the recipient of the package’s arrival without the need for constant tracking or physical interaction. By synchronizing with a food delivery application, alerting device (200) provides a visual and/or audio reference for the delivery and saving time. By synchronizing with a ride sharing application, alerting device (200) provides a visual and/or audio reference for fare pick up, saving time. In addition, the driver of the ride sharing car can also have a unique signal. This signal can be used by the user of the ride sharing app to make sure he or she has the correct vehicle. By having the driver and the rider generating unique signals, it creates a much safer environment for the rider and driver by ensuring that they find each other. It also allows the driver not to take their eyes off of the road to look at their phone to make sure they are close to the pickup location. In one or more preferred embodiments of the present invention, the alerting device (200) uses a light on the vehicle as a signaling module for generating alerts when a person or user approaches the vehicle. In a similar fashion, when the user is picked by a taxi or ride share service, the phone of the user flashes a pattern, color, or other signal, once the vehicle crosses a pre-determined distance, alerting both rider and the driver, that they are nearby and now may be on the lookout for each other. In another example, the person receiving a delivery, the phone of the user flashes a pattern, color, or other signal, once the approaching person and vehicle crosses a pre-determined distance, alerting both parties that they are nearby and now may be on the lookout for each other.

In one or more embodiments of the present invention, by using this device and technology, a person may now deliver food to anyone, just about anywhere, with more efficiency. For example, a person at a park orders food while a child plays a sport. The food delivery personnel may easily find the customer by the flashing of lights on the customer’s car or the customer’s phone when the delivery is near. Identification of the customer by the food service company may be confirmed by matching the previously mentioned codes on the respective phones or devices.

FIG. 4B illustrates an exemplary embodiment of utilization of alerting device (200) on vehicles. During distress situation within a vehicle or cars, a person who dials 911 while occupying their vehicle, have the option of the car lights flashing SOS, by syncing the car lights with the mobile application. The help may more easily locate the person in distress. This can assist emergency personnel in situations where there is low visibility, such as, for example, in snowy, rainy, foggy, or congested conditions. Alerting device (200) may also alert others to stop to assist the person in need.

In the same or other embodiments of the present invention, a tow truck may more easily identify a vehicle that has requested assistance by flashing the lights to a pre-specified pattern. An example of such a situation comprises a busy parking lot. Additionally, alerting device (200) syncs with a vehicle’s lights to flash an SOS signal from the interior, enabling effective communication with tow companies during vehicle breakdowns or towing requirements. Alerting device (200) provides a clear and easily identifiable distress signal, expediting the response time of towing services. To assist tow companies, alerting device (200) synchronizes with the car’s lights and emits an SOS signal from the interior, indicating the need for towing assistance.

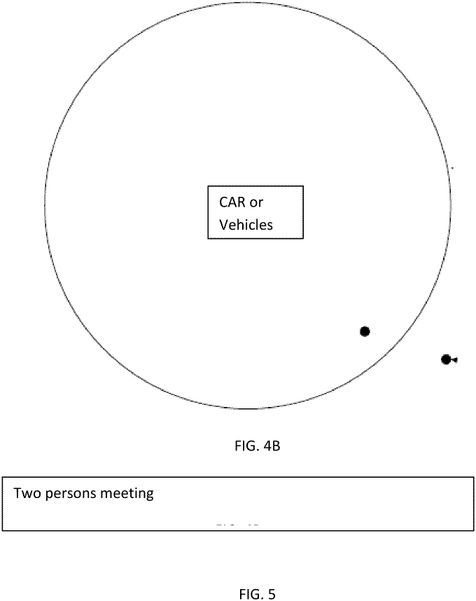

FIG. 5 illustrates a trust verification system for ride share services, dating services, or any similar service. Alert device (200) collects information from nearby devices. The alerting device (200) can comprise applications for creating safer encounters for dating apps or facilitating pickups arranged through platforms like Facebook Marketplace or ride share applications. Furthermore, this technology offers a trust verification system, particularly beneficial for ride share services. By incorporating a unique color pattern or number combination, the alerting device (200) helps ensure the right passenger is matched with the correct driver or vice versa. The alerting device (200) mitigates the risk of fraudulent encounters, creating safer transportation experiences.

Alerting device (200) opens up possibilities for applications such as safe encounters in online dating scenarios or facilitating pickups arranged through social media platforms or marketplace platforms. By leveraging the data collected, alerting device (200) provides additional context and assurance in these interactions. In one exemplary embodiment of the present invention, alerting device (200) is utilized in dating services or any trade service. Fake identification may be rampant and criminals have used fake identification to gain trust and access.

In an exemplary embodiment of the present invention, when two people agreed to meet for a meeting such as a business meeting or a personal meeting, a visual code displayed on phones of both parties, confirming that the people involved have previously agreed to a meeting and they are people prearranged to meet. In another exemplary embodiment of the present invention, when a person utilizing any trade service or any meeting services, a visual code and/or an audio alert displayed on phones of both parties, confirming that the people involved have previously agreed to a meeting and they are the prearranged people. This prevents criminals from gaining unauthorized access to people’s homes. If the code does not match, the person is not allowed for entering premises. In another exemplary embodiment of the present invention, when a person utilizing dating services, a visual code displayed on phones of both parties, confirming that the people involved have previously agreed to a meeting. Alerting device (200) can provide a higher level of comfort for mainly people when meeting a stranger for the first time.

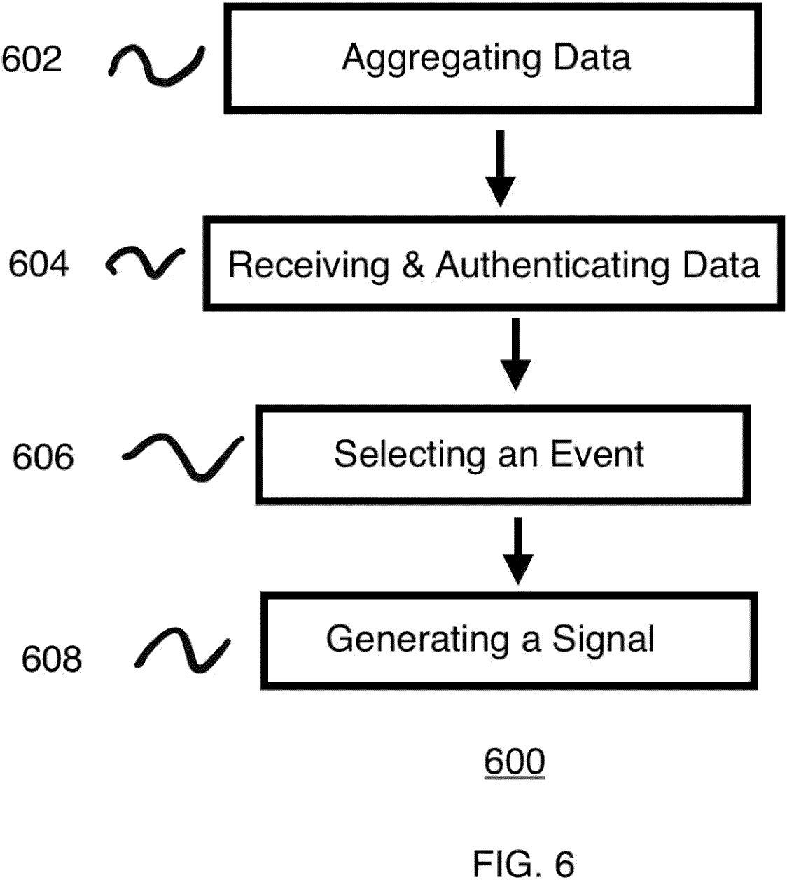

FIG. 6 illustrates an example of method (600) for identifying a location based on one or more events. Method (600) comprises a step (602) of aggregating the data from the one or more events. The location is either location of a person, a building, shelter, vehicles, cars, delivery personnel, or any other objects. In one embodiment of the present invention, the data aggregator (102) works in conjugation with mobile applications for collecting data of one or more events. The mobile application is any delivery application, dating application, car servicing application, towing services application, ride sharing application, food delivery application, emergency distress application, or other mobile application. The data aggregator (102) collects data from nearby mobile devices, a wireless network, or capture legally permissible cell phone information. In one embodiment of the present invention, the one or more event is either emergency situation, food delivery, tracking of a person, towing of a vehicle, dating services, trade services, ride sharing services, emergency situation, or other applications.

Further, method (600) comprises a step (604) of receiving and authenticating the data received to generate an authenticated data related to the one or more events. Further, method (600) comprises a step (606) of selecting an event from the authenticated data based on a set of pre-defined rules. In one embodiment of the present invention, the set of pre-defined rules comprises a location dependent occurrence of the one or more events and generation of types of alerts.

Further, method (600) comprises a step (608) that comprises generating a signal based on a selected event. Further, method (600) comprises a step (610) of at least one alert based on the signal to identify and verify the location. The alert is customizable alert that is customized according to requirements of the user.

In addition, according to one or more embodiments of the present invention, any of the examples of embodiments presented herein can be used in cooperation with artificial intelligence capabilities. As an example, AI can be used to monitor a location, determine whether there is an emergency situation, and order a signal to be sent.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. A system for identifying a location based on one or more events comprising:
a data aggregator, wherein the data aggregator collects data from the one or more events;
a processor, wherein the processor includes:
an authentication module for receiving and authenticating the data from the data aggregator to generate an authenticated data;
a selection module for selecting an event based on the authenticated data, wherein the event is selected by applying a set of pre-defined rules on the authenticated data; and
a generation module for generating a signal based on the event to identify the location; and
a signaling module for generating at least one alert based on the signal to identify the location.

2. The system in accordance with claim 1, wherein the location comprises at least one of: a building, a shelter, a vehicle, a delivery person, or a user.

3. The system in accordance with claim 1, wherein the set of pre-defined rules are based on the one or more events, the location, and the at least one alert.

4. The system in accordance with claim 1, wherein the at least one alert comprises at least one of a visual alert or an audible alert.

5. The system in accordance with claim 4, wherein the signaling module comprises at least one of a smart light, a smart phone, a smart bulb, a porch light, or a flashlight.

6. The system in accordance with claim 1, wherein the at least one alert comprises a visual alert and an audible alert.

7. The system in accordance with claim 1, wherein the data aggregator collects the data of the one or more events through an application installed on an electronic device.

8. The system in accordance with claim 7, wherein the electronic device comprises at least one of a smart phone, a mobile device, a tablet, or a laptop.

9. The system in accordance with claim 7, wherein the mobile application comprises at least one of a delivery application, a dating application, a car servicing application, a towing services application, a ride sharing application, a food delivery application, or an emergency distress application.

10. The system in accordance with claim 1, wherein the one or more events comprises at least one of an emergency situation, a food delivery, tracking of a person, towing of a vehicle, a dating service, a trade service, or a ride sharing service.

11. An alerting device for providing an alert based on identification of a location, wherein the alerting device comprises:
a data aggregator, wherein the data aggregator collects data from one or more events;
a processor, wherein the processor includes:
an authentication module for receiving and authenticating the data from the data aggregator to generate an authenticated data; and
a selection module for selecting an event based on the authenticated data, wherein the event is selected by applying a set of pre-defined rules on the authenticated data; and
an alerting module, wherein the alerting module includes:
a generation module for generating a signal based on the event to identify the location; and
a signaling module for generating the alert from the location.

12. The alerting device in accordance with claim 11, wherein the alerting device comprises emitting one of a multi-color light, a predefined pattern of light or flashing of light.

13. The alerting device in accordance with claim 11, wherein the alerting device is capable of generating audible alerts of different frequencies.

14. The alerting device in accordance with claim 11, wherein the alerting device is capable of generating a specific color pattern to match with the user.

15. A method for identifying a location based on one or more events, wherein the system comprises:
aggregating the data from the one or more events;
authenticating the data to generate an authenticated data;
selecting an event based on the authenticated data by applying a set of pre-defined rules on the authenticated data;
generating a signal based on the event to identify the location; and
generating an alert based on the location.
